(19) United States
(12) Patent Application Publication
(10) Pub. No.: US 2018/0358855 A1
(43) Pub. Date: Dec. 13, 2018

(54) PERMANENT MAGNET MOTOR WITH EXTERNAL ROTOR

(71) Applicant: Hsia-Yuan HSU, Taichung (TW)

(72) Inventor: Hsia-Yuan HSU, Taichung (TW)

(21) Appl. No.: 15/616,618

(22) Filed: Jun. 7, 2017

(51) Int. Cl. H02K 1/27

(52) U.S. Cl. CPC H02K 1/2786

(57) ABSTRACT

A permanent magnetic motor with external rotor includes a first housing provided with a foundation plate having its circumference formed integral with a circumferential wall and its interior formed with an accommodating space. Plural permanent magnets are equidistantly and annularly disposed inside the circumferential wall of the first housing, and a second housing to be covered with the first housing has its outer circumference annularly provided with a protruding-up extension portion, which is slightly the same as the circumferential wall in height. Thus, magnetic permeance area can be doubled via the circumferential wall and the extension portion, able to make magnetic conduction smooth and increase output power of the permanent magnet motor with external rotor.

### BACKGROUND OF THE INVENTION

### 1. Field of the Invention

This invention relates to a motor, particularly to a permanent magnet motor with external rotor.

### 2. Description of the Prior Art

A conventional permanent magnet motor includes a stator and a rotor. The stator contains a mandrel and an electromagnet portion, which is annularly provided around the mandrel and wound thereon with coils. The rotor is mounted at the outer circumference of the stator, containing an upper cover, a plurality of permanent magnets and a lower cover, with the upper cover and the lower cover oppositely combined together. The upper cover is annularly formed with a circumferential wall, and the permanent magnets are equidistantly fixed inside the circumferential wall of the upper cover. Thus, different magnetic poles between adjacent permanent magnets of the rotor and the electromagnet portion of the stator will attract each other or repel each other to enable the rotor to operate and rotate continuously.

However, when the conventional permanent magnet motor is operated, the circumferential wall of the upper cover will produce magnetic conduction, letting magnetic energy smoothly pass therethrough. If the circumferential wall of the upper cover is of thinner thickness, it is easy to cause magnetic saturation phenomenon and make the output power of the motor become less and, if the circumferential wall of the upper cover is of greater thickness, the output power of the motor can be reinforced, but the relative cost will become high. Therefore, observing the above-mentioned drawbacks, the inventor of this invention thinks that the conventional permanent magnetic motor is necessary to be further ameliorated and thereupon devises this invention.

### SUMMARY OF THE INVENTION

The objective of this invention is to offer a permanent magnet motor with external rotor, able to increase magnetic permeance area, and enhance overall efficiency and output power of the motor.

The permanent magnet motor with external rotor in the present invention includes a first housing mounted at the outer circumference of a stator. The first housing is provided with a foundation plate having its circumference formed integral with a circumferential wall and its interior formed into an accommodating space, and the first housing is further provided with a shaft hole and an opening respectively communicating with the accommodating space, with the shaft hole passing through the foundation plate. A plurality of permanent magnets are equidistantly and annularly disposed inside the circumferential wall of the first housing, and a second housing is provided with a cover plate to be covered with the opening of the first housing. The cover plate of the second housing has its circumference formed integral with a protruding-up extension portion extending toward the first housing.

The permanent magnet motor with external rotor in the present invention is able to double the magnetic permeance area to make magnetic permeance smooth and increase output power of the permanent magnet motor with external rotor by means of the circumferential wall of the first housing and the extension portion of the second housing.

### BRIEF DESCRIPTION OF DRAWINGS

This invention will be better understood by referring to the accompanying drawings, wherein:

FIG. 1 is an exploded perspective view of a permanent magnet motor with external rotor in the present invention;

FIG. 2 is a cross-sectional view of a first preferred embodiment of the permanent magnet motor with external rotor in the present invention;

FIG. 3 is a cross-sectional view of a second preferred embodiment of a permanent magnet motor with external rotor in the present invention; and

FIG. 4 is a cross-sectional view of a third preferred embodiment of a permanent magnet motor with external rotor in the present invention.

### DETAILED DESCRIPTION OF THE PREFERRED EMBODIMENT

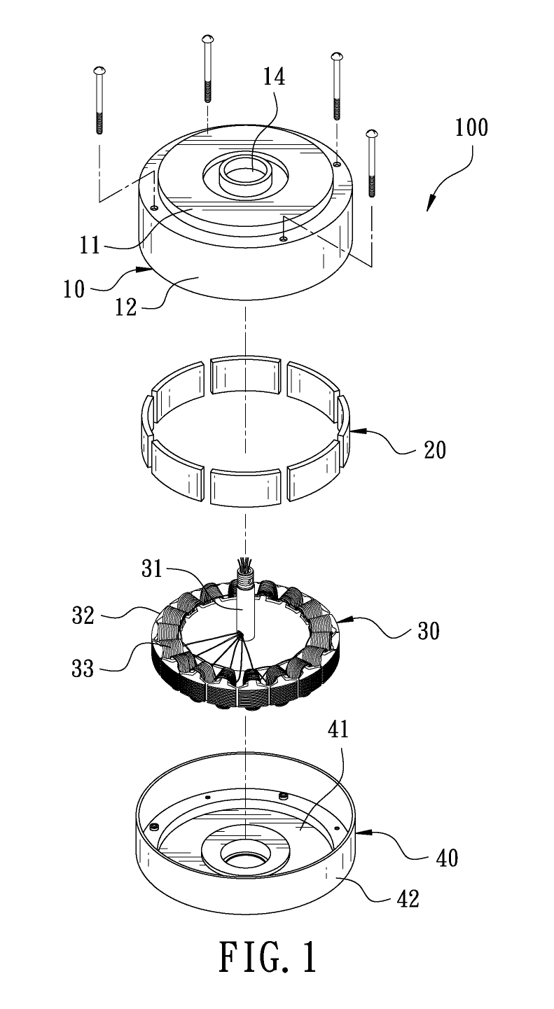

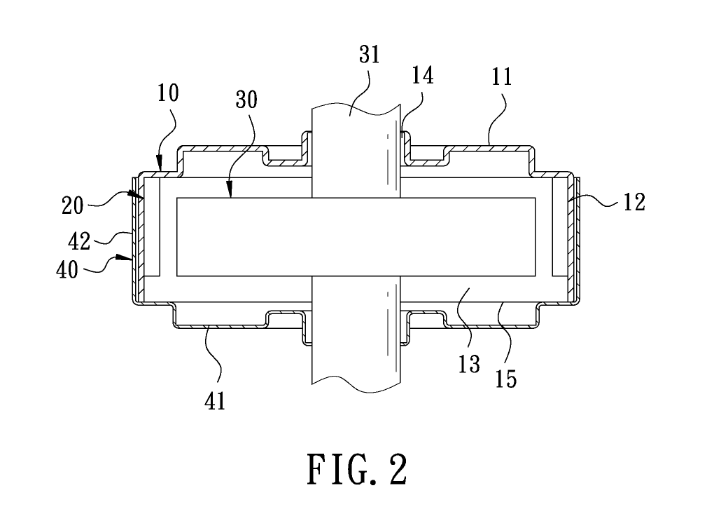

A first preferred embodiment of a permanent magnet motor with external rotor 100 in the present invention, as shown in FIGS. 1 and 2, includes a first housing 10, a plurality of permanent magnets 20, a stator and a second housing 40 as main components combined together.

The first housing 10 is composed of magnetic permeance material, which is iron in this preferred embodiment. The first housing 10 is provided with a foundation plate 11 having its circumference formed integral with a circumferential wall 12 and its interior formed into an accommodating space 13. Further, the first housing 10 is provided with a shaft hole 14 and an opening 15 respectively communicating with the accommodating dating space 13, with the shaft hole 14 passing through the foundation plate 11. The first housing is integrally formed with the foundation plate 11 and the circumferential wall 12.

The permanent magnets 20 are equidistantly and annularly disposed inside the circumferential wall 12 of the first housing 10, and two ends of each permanent magnet 20 are respectively formed with an opposite magnetic pole.

The stator 30 is received in the accommodating space 13 of the first housing 10 and provided with a mandrel 31 and an electromagnet portion 32. The mandrel 31 is inserted in the shaft hole 14 of the first housing 10, and the electromagnet portion 32 is disposed around the mandrel 31 and wound thereon with coils 33.

The second housing 40 is composed of magnetic permeance material and provided with a cover plate 41 to be covered with the opening 15 of the first housing 10. The cover plate 41 has its circumference formed integral with a protruding-up extension portion 42 extending toward the first housing 10. In this preferred embodiment, the first housing 10 is mounted on the second housing 40, with the protruding-up extension portion 42 serving as a ring wall. Further, the internal diameter of the extension portion 42 of the second housing 40 is larger than the external diameter of the circumferential wall 12 of the first housing 10, letting the extension portion 42 mounted around the outer side of the circumferential wall 12 of the first housing 10. The second housing is integrally formed with the cover plate 41 and the extension portion 42.

Referring to FIGS. 1 and 2, the extension portion 42 is mounted around the outer side of the circumferential wall 12, and the circumferential wall 12 and the extension portion 42 are somewhat the same in height, enabling the extension portion 42 to extend to a relative position of the foundation plate 11 of the first housing 10. Thus, when motor 100 is started, the coils 33 of the stator 30, through current magnetic effect, will actuate the electromagnet portion 32 to produce different magnetic poles, letting the electromagnet portion 32 and the permanent magnets 20 produce mutual attraction and mutual repulsion effect to enable the permanent magnets to rotate successively around the electromagnetic portion 32. Further, since both the circumferential wall 12 and the extension portion 42 are made of magnetic permeance material; therefore, the circumferential wall and the extension portion 42 are able to conduct magnetism to let magnetic energy pass therethrough, thus able to double a magnetic permeance area, reduce magnetic saturation for making magnetic permeance smooth and increase output power of the permanent magnet motor with external rotor 100 and furthermore, the extension portion 42 can be integrally molded with the second housing 40, able to lower cost.

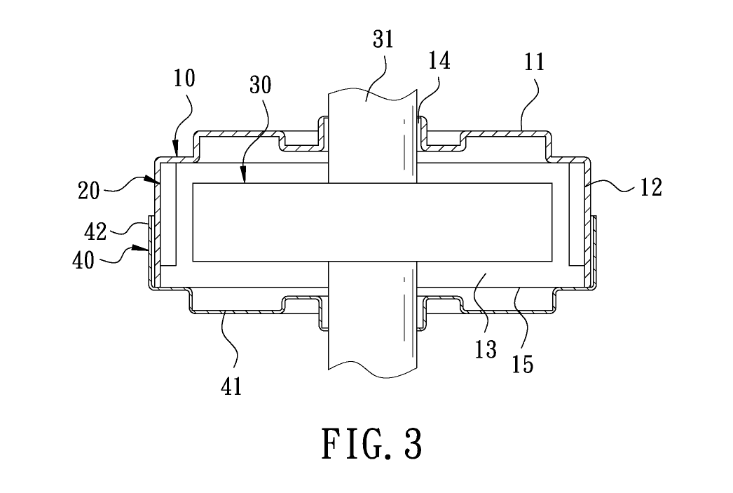

A second preferred embodiment of a permanent magnet motor with external rotor in the present invention, as shown in FIG. 3, has almost the same structure as that in the first preferred embodiment, except that the extension portion 42 in the second preferred embodiment is extended to an intermediate location of the permanent magnets 20; therefore, the magnetic permeance area can be doubled via the circumferential wall 12 and the extension portion 42, able to reduce magnetic saturation, render magnetic permeance smooth and increase output power of the permanent magnet motor with external rotor 100.

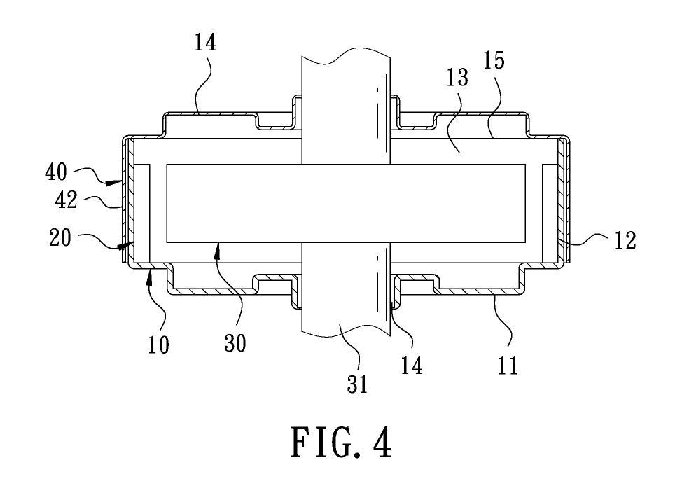

A third preferred embodiment of a permanent magnet motor with external rotor in the present invention, as shown in FIG. 4, is the same in structure as the first preferred embodiment, except that the second housing 40 is mounted on the first housing 10 and thus, the magnetic permeance area can be doubled, able to decrease magnetic saturation for making magnetic permeance smooth and increase output power of the permanent magnet motor with external rotor 100.

While the preferred embodiments of the invention have been described above, it will be recognized and understood that various modifications may be made therein and the appended claims are intended to cover all such modifications that may fall within the spirit and scope of the invention.

What is claimed is:

1. A permanent magnet motor with external rotor comprising:
a first housing provided at an outer circumference of a stator, said stator provided with a mandrel and an electromagnet portion, said electromagnet portion disposed around said mandrel and wound with coils, said first housing provided with a foundation plate, said foundation plate having a circumference formed integral with a circumferential wall, and an interior formed into an accommodating space, said first housing provided with a shaft hole and an opening respectively communicating with said accommodating space, said shaft hole passing through said foundation plate, said shaft hole corresponding to said mandrel;
a plurality of permanent magnets equidistantly and annularly disposed inside said circumferential wall of said first housing; and
a second housing provided with a cover plate to be covered with said opening of said first housing, said cover plate having a circumference formed integral with a protruding-up extension portion, said protruding-up extension portion extending toward said first housing;
Thus, able to increase a magnetic permeance area via said extension portion to make magnetic permeance smooth and increase output power of said permanent magnet motor with external rotor.

2. The permanent magnet motor with external rotor as claimed in claim 1, wherein said extension portion extends to an intermediate location of said permanent magnets.

3. The permanent magnet motor with external rotor as claimed in claim 1, wherein said circumferential wall and said extension portion are slightly the same in height to enable said extension portion to extend to a relative position of said foundation plate.

4. The permanent magnet motor with external rotor as claimed in claim 1, wherein said first housing and said second housing are composed of magnetic permeance material.

5. The permanent magnet motor with external rotor as claimed in claim 1, wherein an internal diameter of said extension portion is larger than an external diameter of said circumferential wall, said extension portion annularly mounted at an outer side of said circumferential wall of said first housing.
